(19) United States
(12) Patent Application Publication
(10) Pub. No.: US 2007/0050369 A1
(43) Pub. Date: Mar. 1, 2007

(54) Accessing file under confinement

(76) Inventors: Marc D. Stiegler, Kingman, AZ (US); Alan H. Karp, Palo Alto, CA (US); Tyler Close, Menlo Park, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/590,131

(22) Filed: Oct. 31, 2006

Related U.S. Application Data
(63) Continuation-in-part of application No. 11/047,015, filed on Jan. 31, 2005.

(51) Int. Cl. G06F 17/30

(52) U.S. Cl. 707/9

(57) ABSTRACT

A method of launching an application in a computer system, the method comprising launching the application in a restricted user account, intercepting at least one request for an operation on a file, the at least one request comes from launching the application, determining whether the at least one file operation request is acceptable, and responsive to the at least one file operation request determined to be acceptable, forwarding the file operation request for the operation on the file on behalf of the application launched in the restricted user account.

### PRIORITY

This application is a continuation-in-part of U.S. patent application Ser. No. 11/047,015, filed Jan. 31, 2005 (Applicant's Docket No. 200400890-1), which is herein incorporated by reference in its entirety.

### BACKGROUND

In the past few years, computer viruses have caused damage to computer systems throughout the world. A computer virus is a program capable of operation on a computer system, such as a personal computer, that is self-replicating and that can “infect” other programs by modifying them or their environment such that a call to an infected program results in an action that the user may not like.

Computer systems today typically run operating systems having user accounts for users of the systems. A user logs into the computer system under a user account and has authority to add, edit, delete or use most of the resources available in the computer system. Additionally, applications running in the user's account have the same authority as the user. This arrangement provides applications with too much authority and presents destructive applications, such as a computer viruses, with a doorway to most of the resources in the computer system. For instance, if an application is infected by a virus, the virus may be able to spread to any resource that the user may access including other files located on the computer system. Thus, for example, the virus may be able to read any file the user can read, and modify or delete any file the user can modify or delete. Conventional virus detection software is often unable to stop the spread of viruses, as exemplified by periodic outbreaks of computer virus infections. On the other hand, running a user's intended application under an account separate from the user's account would deny the application's authority to modify most of the resources in the computer system as needed to carry out the user's wishes, which is too little authority.

### BRIEF DESCRIPTION OF THE DRAWINGS

Embodiments are illustrated by way of example and not limited in the following figure(s), in which like numerals indicate like elements, in which:

FIGS. 1A-B illustrate block diagrams of a system for launching an application in a restricted user account, in which additional Principle Of Least Authority (POLA) confinement is applicable in accordance with various embodiments of the present invention.

FIG. 1C illustrates a Venn diagram 150 of a user account and restricted user accounts in accordance with an example of a computer system, in accordance with an embodiment of the present invention.

FIG. 2 illustrates an interaction between the authority manager and each restricted user account depicted in FIGS. 1A-B, in accordance with one embodiment of the present invention.

FIG. 3 illustrates a process flow 300 for applying to a restricted user account additional POLA confinement with respect to files in a file system, in accordance with an embodiment of the present invention.

FIG. 4 illustrates a block diagram of a computer system that may run the application(s) 102 depicted in FIGS. 1 and 2.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

Methods and systems are described herein for enabling one or more applications to launch or run under Principle of Least Authority (POLA) confinement with respect to files in a file system, such that each confined application has access to only those files that it needs to fulfill the purpose of the user launching the application(s). As referred herein, POLA, in general, gives a person or thing the least authority it needs to perform a task. By implementing POLA in a computer system, the system controls an application's access, through controlling access permissions, to resources within the computer system. In one example, the system may control an application's access to the resources such that the application may have access to only the executable file needed to run the application and any other file necessary to complete a task. By controlling the access to resources, the computer system can be shielded from an application infected with a virus or any other malicious applications. One example of limiting an application's permissions to resources may include creating a restricted user account and confining the application to run within the restricted user account.

Throughout the present disclosure, reference is made to a computer or system resource, which is any physical or virtual system component of a computer system. Thus, examples of a resource include physical system components such as memory disks, processors, and memory circuits and virtual system components such as files, network connections, memory areas, and memory addresses.

Reference is also made to a restricted user account, which may be defined as an account provided with access to fewer resources than the user's login account. A software application, to be confined, runs within the restricted user account. The restricted user account may have authority to access an executable file for the application and any other file necessary to complete a task for the application. For example, the restricted user account, and likewise the application, may have read only access to an executable file which started the application and read/write access to support files or directories containing the support files for running the application.

The restricted user account may be an existing restricted user account with a predetermined set of authorities relevant for the application. The predetermined set of authorities is modifiable to provide flexibility to the system. In addition, a computer system may include a plurality of existing restricted user accounts for various applications.

In another example, the restricted user account may be a new restricted user account created and assigned a predetermined set of authorities for launching the application. Once the new restricted user account is created, an application may run in the new restricted user account and access the same resources that the new restricted user account may access. Once the application terminates, the new restricted user account may be deleted. In some respects, this may be viewed as a “single-use” restricted user account.

Reference is also made to a file operation request. A file operation may be defined as the reading of a file, the writing to the file, or both. Thus, a file operation request refers to a request to read a file, write to the file, or both.

Reference is also made to an identifier of an application. Examples of the identifier may include a file name and/or a path name of an executable file used to run the application. The identifier may be an original identifier that is the original file name and/or the path name of the executable file for launching the application. The identifier may also be a new identifier that is the new file name and/or the new path name of the executable file for launching the application.

Reference is also made to a polalauncher. The polalauncher may be defined as an executable file, script, or application configured to run an application within a restricted user account. The polalauncher may be identified with the original identifier of the application. The polalauncher may also be configured to send a request to an authority manager (defined below) to run the application within an existing restricted user account. In another example, the polalauncher may also be configured to send a request to an authority manager to create a new restricted user account and to run the application within the new restricted user account. The polalauncher may also include information relevant to the application such as the new identifier of the application, the existing restricted user account to use for launching the application, and/or a set of authorities with which to create a new restricted user account to use for launching the application.

Reference is also made to an authority manager. The authority manager may be defined as an application or script configured to receive a request from a polalauncher and to run an application, identified by the polalauncher, in a restricted user account. The authority manager may be configured to use one of a plurality of existing restricted user accounts that is designated for the application. In another example, the authority manager may be configured to create a new restricted user account and to delete the new restricted user account when the application terminates.

In an example, a computer system includes an executable file for launching an application; the executable file includes an original identifier. The original identifier is changed to a new identifier while a polalauncher, created for the application, is given the original identifier. The polalauncher is an executable file, program or script configured to send a request to an authority manager to run the application. Whenever a user or another program in the computer system attempts to run the application using the original identifier, the polalauncher runs (and sends a request to an authority manager to run the application in a restricted user account) instead of the application launching in the user's account. The authority manager receives the request and runs the application, using the new identifier, in a restricted user account.

Access to the application is restricted by hiding the executable file from a user or another program attempting to run the application. This restriction may be enforced by setting permissions on the executable file preventing access by the restricted user account. Alternatively, the permissions may also be set so that only the authority manager has permission to run the executable file. This ensures that the application runs in a restricted user account rather than a non-restricted user account, which prevents virus spreading. For example, a user clicks on an e-mail attachment, which contains a “macro” type virus, in an e-mail program. The e-mail program, in response, attempts to run the application associated with attachment but instead runs the polalaucher which then runs the application in a restricted user account thus confining the virus. The virus may try to spread or access other parts of the user's system, however, it will be confined to accessing only those resources available to the restricted user account. If these precautions were not in place, the e-mail program would run the application in a non-restricted user account and the virus may spread throughout the user's entire data space, and often throughout the entire computer system.

In another example, the polalauncher's request includes the new identifier of the executable file for the application (that is, the new identifier of the application) and the particular existing restricted user account to use in order to run the application. The authority manager receives the request and runs the application, using the new identifier, in the existing restricted user account. A plurality of existing restricted user accounts may have been previously created; one for each application in the computer system, each one having a predetermined set of authorities for the application with which it is associated.

In another example, the polalauncher's request includes the new identifier of the executable file for the application and a set of authorities for the application. The authority manager receives the request; creates a new restricted user account using the set of authorities; and runs the application, using the new identifier, in the new restricted user account. Alternatively, the authority manager may use a predetermined set of authorities to create the new restricted user account and modify the predetermined set of authorities according to the set of authorities received in the request from the polalauncher. In either case, when the application terminates, the authority manager may delete the new restricted user account.

In another example, a computer system may be configured such that substantially all executable files for substantially all applications have been provided with new identifiers and polalaunchers have been provided having the applications' original identifiers. In this manner, whenever a user or another program in the computer system attempts to run any application using any one of the original identifiers, the polalauncher runs and sends a request to an authority manager to run the application. Therefore, the user's entire computer system is protected.

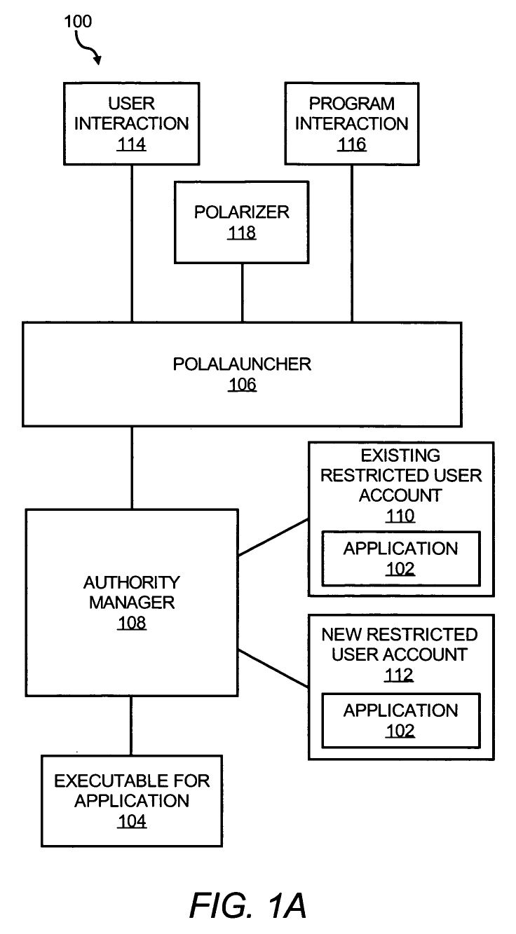

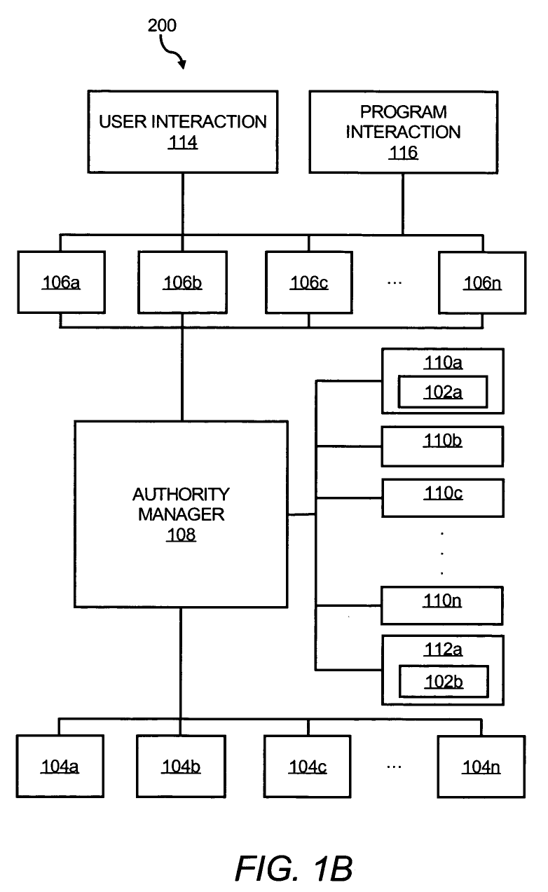

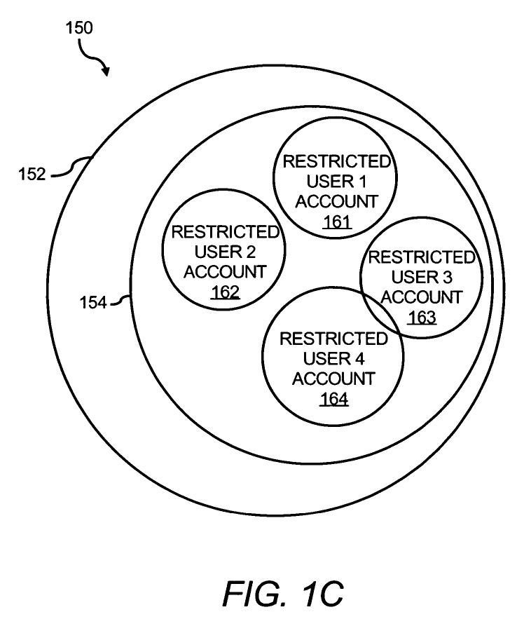

FIG. 1A illustrates a block diagram of a system 100 for launching an application in a restricted user account, in which additional POLA confinement is applicable in accordance with one embodiment of the present invention. The system 100 includes an application 102, an executable file 104, a polalauncher 106, an authority manager 108, and may include an existing restricted user account 110 and/or a new restricted user account 112. The executable file 104 is for launching the application 102. The polalauncher 106 was created to replace the executable file 104 for the application 102. The polalauncher 106 may be an executable file located in the computer system 100. The polalauncher 106 has an original identifier of the executable file 104, which has a new identifier after polarization. The polalauncher 106 may be executed either from user interaction 114 or program interaction 116. In either case, the polalauncher 106, upon execution, sends a request to the authority manager 108 including the new identifier for the executable file 104 of the application 102.

The system 100 may also include a polarizer 118. The polarizer 118 may be responsible for creating the existing restricted user account 110 and the polalauncher 106. The polarizer 118 may also be responsible for changing the original identifier of the executable file 104 to the new identifier. For example, the polarizer 118 may change a name of “TextEditor.exe” to “TextEditor1.exe” and create a polalauncher having the name “TextEditor.exe.” When the user or another application attempts to run “TextEditor.exe,” the polalauncher runs and sends the new identifier “TextEditor1.exe” to the authority manager to run the “TextEditor” application.

In one example, the authority manager 108 receives the request from the polalauncher 106 and runs the application 102 within the existing restricted user account 110. The existing restricted user account 110 was previously created for the application 102 and provided with a predetermined set of authorities that are based on an Access Control List (ACL). As referred herein, an ACL operates as a list of authorized accessors, and it includes entries identifying the user accounts in the computer system, and permissions of the user accounts to access the resource to which the ACL is attached. That is, there is an ACL attached to each single resource in the file system that lists the user accounts or groups that can access the single resource. Accordingly, the predetermined set of authorities maintained by the authority manager 108 should be distinguished from each ACL that is attached to a system resource.

The polalauncher 106 may also identify the existing restricted user account 110 in the request to the authority manager 108. Alternatively, the authority manager 108 may include a table, database or other data structure for correlating the new or original identifier with the existing restricted user account 110. The authority manager 108 may also be configured to receive a request from a user of the application 102 to access other computer resources and modify their ACLs accordingly.

In another example, the authority manager 108 receives the request, creates a new restricted user account 112, and runs the application 102 within the new restricted user account 112. The polalauncher 106 may also send in the request a predetermined set of authorities for creating the new restricted user account 112. In this case, the authority manager 108 uses the predetermined set of authorities to create the new restricted user account 112. Alternatively, the authority manager 108 may include a predetermined set of authorities (hereinafter, “list of authorities”) for creating any new restricted user account and the polalauncher 106 may request a modification of the predetermined set of authorities according to requirements of the application 102. As in the example described above, the authority manager 108 may also be configured to receive a request from a user of the application 102 to access other computer resources and modify the predetermined set of authorities accordingly.

In either example, the polalauncher 106, by having the original identifier of the application 102, provides a failsafe for a user or another program attempting to run the application 102 directly and outside of a restricted user account. Because the original identifier points to the polalauncher 106 and the new identifier points to the executable 104, the user will not accidentally run the application 102 in a non-restricted user account. Additionally, any program attempting to execute the application 102 will instead execute the polalauncher 106 for the application 102. This mechanism ensures that the application 102 runs in a restricted user account.

FIG. 1B illustrates a block diagram of a system 200 for launching an application in a restricted user account, in which additional POLA confinement is applicable in accordance with another embodiment of the present invention. The system 200 includes applications 102a and 102b, executable files 104a-104n, polalaunchers 106a-106n, an authority manager 108, and may include existing restricted user accounts 110a-110n and/or a new restricted user account 112a. The executable files 104a and 104b are for launching applications 102a and 102b, respectively. The polalaunchers 106a and 106b were created for the applications 102a and 102b and may be files in the computer system 200 having original identifiers of the executable files 104a and 104b, which both have new identifiers. The polalaunchers 106c-106n were created for the executable files 104c-104n, respectively, of other applications. The polalaunchers 106a-106n may be executed either from user interaction 114 or program interaction 116. In either case, any of the polalaunchers 106a-106n, upon execution, sends a request to the authority manager 108 including the new identifier for the corresponding executable file 104a-104n.

In one example, the authority manager 108 receives the request from the polalauncher 106a and runs the application 102a within the existing restricted user account 110a. The existing restricted user account 110a was previously created for the application 102a and provided with a predetermined set of authorities. The polalauncher 106a may also identify the existing restricted user account 110a in the request to the authority manager 108. Alternatively, the authority manager 108 may include a table, database or other data structure for correlating the new or original identifier with the existing restricted user account 110a. The authority manager 108 may also be configured to receive a request from a user of the application 102a to access other computer resources and modify their ACLs accordingly.

In another example, the authority manager 108 receives the request from polalauncher 106b, creates a new restricted user account 112a, and runs the application 102b within the new restricted user account 112a. The polalauncher 106b may also send in the request a predetermined set of authorities for creating the new restricted user account 112a. In this case, the authority manager 108 uses the predetermined set of authorities to create the new restricted user account 112a. Alternatively, the authority manager 108 may include a predetermined set of authorities (hereinafter, “list of authorities”) for creating any new restricted user account and the polalauncher 106b may request a modification of the predetermined set of authorities according to requirements of the application 102b. As in the example described above, the authority manager 108 may also be configured to receive a request from a user of the application 102b to access other computer resources and modify the predetermined set of authorities accordingly.

Although the above examples show two applications, it should be noted that any number of applications may be run in one of any plurality of existing restricted user accounts or any new existing restricted user account with the system 200. Furthermore, any number of executable files may have any number of corresponding polalaunchers. The letters “a-n” used above is meant to include from one to an arbitrarily large number of possible occurrences of executable files, polalaunchers, existing restricted user accounts, and new restricted user accounts.

When the system 200 is employed in this manner, the predetermined set of authorities for each restricted user account may include permission to access folders or areas having other polalaunchers such that an application running in one restricted user account may run another application. In an example of this configuration, each existing restricted user account 102a-102n and each new restricted user account 112a-112n may have at least read-only permission to polalaunchers 106a-106n. This provides additional flexibility to the system 200. For instance, a user may be using an e-mail application running in a restricted use account. The user receives an e-mail with a text file attachment. The user double clicks on the text file attachment and the e-mail application in conjunction with the operating system attempts to run the application associated with “.txt” files. If the predetermined set of authorities did not include access to the polalauncher for the application associated with the “.txt” file, the e-mail application would return an error to the user. Therefore, the predetermined set of authorities may include access to resources, folders, or areas having the polalauncher for the application associated with “.txt” files.

With reference now to FIG. 1C, there is shown a Venn diagram 150 of a user account and restricted user accounts in accordance with an example of a computer system in accordance with an embodiment of the present invention. An administrative account 152 may have access to all resources available in a computer system while a user account 154 may have access to all resources available to that particular user. User accounts (also referred to as “user login account”), such as user account 154, typically have access to fewer resources than the administrative account 152. However, many user accounts may have access to a large fraction of all resources available in a computer system thus increasing the need for additional protections. The Venn diagram 150 also includes four smaller circles representing four restricted user accounts 161-164 having access to a predetermined set of resources. The first restricted user account 161 has access to the fewest number of resources. For example, the first restricted user account 161 may have access to a single executable file or application. The second restricted user account 162 has access to more resources while the third restricted user account 163 has access to even more resources. In the Venn diagram 150, the fourth restricted user account 164 has access to the most systems resources although access is limited to a subset of the resources available to the user which itself is a subset of resources available in the computer system.

The system resources may be designated by the administrator of the system. For example, the administrator may determine that a particular user needs access to all text files in certain folders but should not have access to any files containing financial information while an administrator of a company should have access to any file containing financial information but not have access to any file containing confidential client information. The administrator may designate permissions to user accounts accordingly.

It should be understood from the present disclosure that any number of restricted user accounts may be created having a plurality of possible permission settings. Additionally, multiple restricted user accounts may be designated for multiple instances of the same application. That is multiple instances of one application may be simultaneously running on the same computer system. For example, a first instance may be started by a user double-clicking on an icon for the application, and while the first instance is running, the user may double-click on the icon again which starts a second instance of the application. Each instance may run in its own restricted user account which can limit the spread of viruses within a computer system.

In one example, the restricted user accounts 161-164 (FIG. 1C) may be accounts for the same user of the user account 154. However, the restricted user accounts 161-164 were created to run the applications described above in an environment where the applications have access to limited resources instead of all the resources of the user account 154. Thus, a virus infecting any of the applications is substantially confined to the resources available to the infected application.

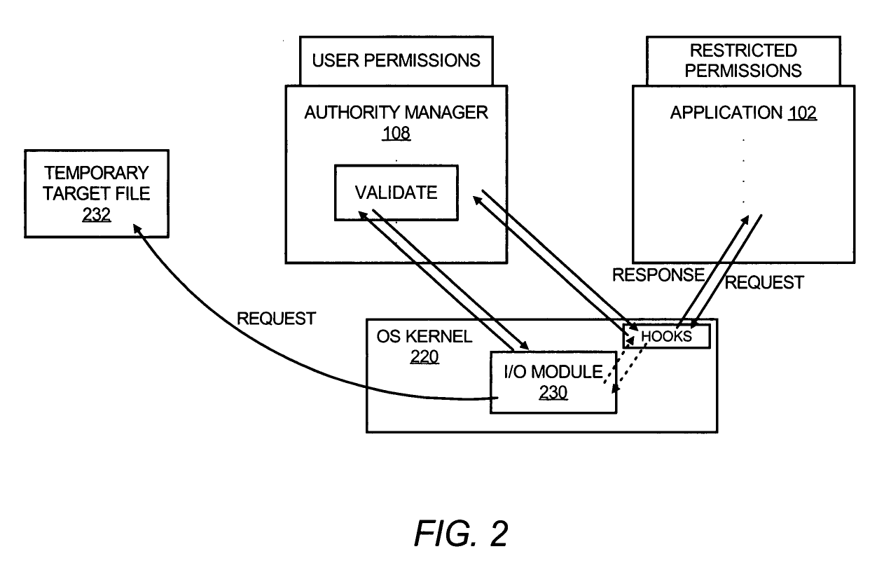

FIG. 2 illustrates an interaction between the authority manager 108 and each restricted user account, such as the existing restricted user account 110 in FIG. 1A (or 110a-110n in FIG. 1B) or the new restricted user account 112 in FIG. 1A (or 112a-112n in FIG. 1B), in either system 100 in FIG. 1A or the system 200 in FIG. 1B so as to enforce POLA confinement of an application with respect to files in a file system, in accordance with one embodiment of the present invention. The authority manager 108 is operable to intercept all file operation requests from the application 102 (or 102a and 102b), determine whether the requests are acceptable or authorized, and appropriately forward the accepted or authorized requests to the Input/Output (I/O) module 230 in an Operating System (OS) kernel 220 of the file system for performance under the full authority of the authority manager 108, instead of the limited authority of the restricted user account 110 (FIG. 1A). If any of the intercepted file operation requests are unacceptable or deemed not authorized, the authority manager 108 provides instructions to the I/O module 230 to forward the unacceptable request to a temporary target file 230 so as to prevent unauthorized access to the intended file in the file system or returns an access denied signal to the program making the request.

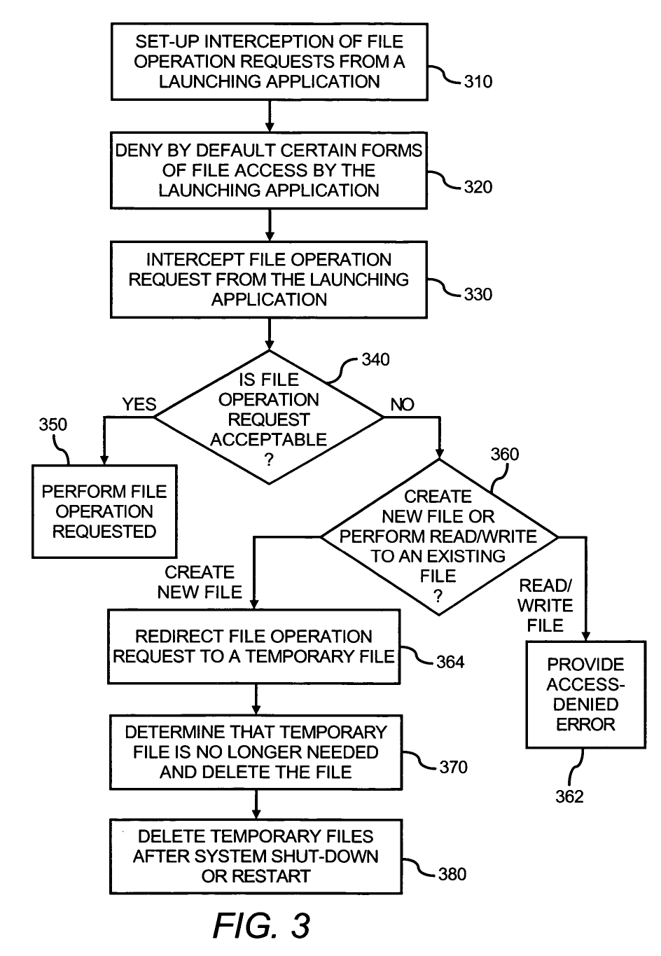

FIG. 3 illustrates a process flow 300 for applying to a restricted user account additional POLA confinement with respect to files in a file system, in accordance with an embodiment of the present invention. For illustrative purposes only and not to be limiting thereof, the method 300 is discussed in the context of the system illustrated in FIG. 2.

At 310, when the authority manager 108 launches the application 102 within a restricted user account (110 or 112), the authority manager 108 sets up program codes in the OS kernel 220 to intercept file operation requests from the application 102. For example, the authority manager 108 may place Dynamic Link Library call interceptors (hereinafter, “DLL hooks”) in the application 102.

At 320, the launch confines the application 102 in such a manner that all forms of access to user files, operating system files, and other sensitive files in the file system to be accessed by the now-confined application 102 are denied by default. This is because the restricted user account 110 (or 112, or both) is not listed in an ACL of any of the resources in the file system. Alternatively, only those forms or types of file access that are deemed dangerous or predetermined to be undesirable are denied by default, as specified by the ACL of each resource. The deny-by-default confinement is crucial lest, for example, a malicious application bypasses the normal DLLs being hooked to make available direct raw kernel calls to the OS kernel 220 (via the I/O module 230 of the OS kernel 220). Such calls will appropriately fail because the requesting process does not have the needed permissions.

At 330, the authority manager 108 intercepts a file operation request from the confined application 102 via the intercepting program code, such as a set of one or more DLL hooks mentioned earlier, whereby such request is redirected to the authority manager 108 instead of to the intended file in the file system for the request.

At 340, upon receiving the file operation request, the authority manager 108 determines whether such a request is acceptable or authorized. That is, whether the file operation request is in a list of authorized accesses, or an Access Control List (ACL), maintained by the authority manager 108 or anywhere that is accessible by the various elements in the system 100.

At 350, if the specified file operation request is acceptable to the list of authorities in the authority manager 108, the file operation is performed as allowed under the full authority of the authority manager 108, which has the full privileges of the user login account. For example, after determining the file operation request is acceptable, the authority manager 108 forwards the accepted or authorized requests to the Input/Output (I/O) module 230 in the OS kernel 220 of the file system for performance under the full authority of the authority manager 108, instead of the limited authority of the restricted user account 110.

The result of the file operation is then returned to the application 102 via the set of DLL hooks or intercepting program code. In one embodiment, if the application 102 has sufficient authority for the file operation request within its confinement, the authority manager 108 simply allows the authorized file operation request and corresponding result to pass directly through without routing them through the authority manager 108 (as shown by the dashed arrows in FIG. 2).

At 360, however, if the specified file operation request is not acceptable to the list of authorities in the authority manager 108, the authority manager 108 next determines whether the specified file operation request from the confined application 102 is trying to create a new file or perform a read/write to an existing file in the file system.

At 362, if the confined application 102 is trying to read or write an existing file in the file system with the specified file operation request, no redirection is performed. Instead, the authority manager 108 sends back to the confined application 102, via the aforementioned set of DLL hooks, an access-denied error.

At 364, however, if the confined application 102 is trying to create a file with the specified file operation request, then the authority manager 108 diverts or redirects the file access request to create a separate target file 230, which is a temporary file that is created or generated by the authority manager 108 for the confined application 102. Referring back to FIG. 2, the authority manager 108 performs the diversion or redirection by providing instructions to the I/O module 230 in the OS kernel 220 to route the file operation request to the temporary target file 230—rather than to an actual intended file to be created in the file system. The temporary file 230 is constructed in a private fashion such that the user does not notice or attempt to use the file. In one embodiment, the temporary file 230 upon which the file operation is performed is hidden and unknown to the user, and the name of the temporary file 230 may be a series of characters that conveys no human meaning. Because the authority manager 108 intercepts the file operation request and maintains full control of such a request, the temporary file 230 does not have to have the same name or location as the actual file name and location specified by the application 102 for the file operation request. The authority manager 108 maintains sufficient persistent information so that it has knowledge of what temporary files have been created even after a system crash.

At 370, once the file operation request is fulfilled (such as when the user terminates the application 102), the authority manager 108 determines that the application 102 no longer needs the temporary file 230, and it deletes the file.

At 380, after the computer system 100 is shut down or restarted, the authority manager 108 also deletes any temporary files that may still exist (such files might still exist, for example, because a system crash interrupted operations).

Accordingly, the process flow 300 adds another layer of protection against viruses and other malicious applications in the launching of an application in a restricted user account, particularly when the use of a separate account, such as a restricted user account created with a predetermined set of authorities, may not be as effective as desired. For example, in a situation where the application 102 is to access files on a non-local drive, such as a network drive, the user frequently has the authority to read/write such files on a network drive. However, the user does not have the authority to edit those ACLs associated with those files, which would be necessary to enable the restricted account to access the files.

It should be understood that the operational mode 300 is applicable with application confinement schemes or mechanisms other than the ACL schemes described above. For example, the user could run each application in a virtual machine environment (using virtualization software from, for example, VMWARE of Palo Alto, Calif.) with deny by default, and filter kernel calls and other file operation requests with the authority manager 108 as described above at the interface to the underlying OS kernel 220 or file system from which file operations are performed.

Some of the steps illustrated in the process flow or operational mode 300 may be contained as a utility, program, subprogram, in any desired computer accessible medium. In addition, the operational mode 300 may be embodied by a computer program, a plurality of computer programs or any other computer readable media, which may exist in a variety of forms both active and inactive in a single computer system or across multiple computer systems. For example, they may exist as software program(s) comprised of program instructions in source code, object code, executable code or other formats for performing some of the steps. Any of the above may be embodied on a computer readable medium, which include storage devices and signals, in compressed or uncompressed form.

Examples of suitable computer readable media or storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated below may be performed by any electronic device capable of executing the above-described functions.

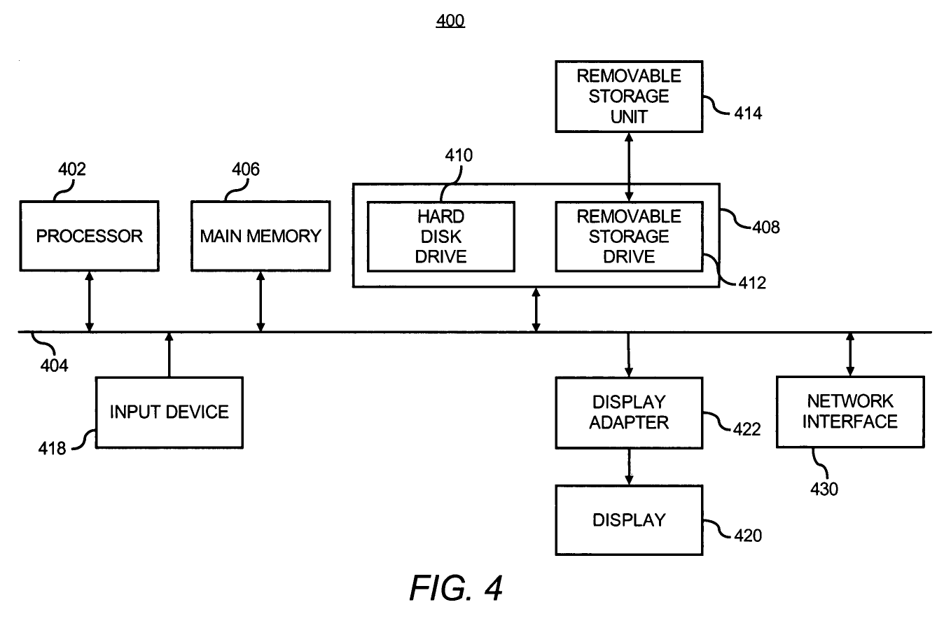

FIG. 4 illustrates an exemplary block diagram of a computer system 400 that may run the application 102 shown in FIG. 1 (or applications 102a-b in FIG. 2). The computer system 400 includes one or more processors, such as processor 402, providing an execution platform for executing software, such as the application 102, the executable file 104, the polalauncher 106, the authority manager 108, and the polarizer 118. The processor 402 may also execute an operating system (e.g., the OS kernel 220 in FIG. 2) for executing the software in addition to performing operating system tasks.

Commands and data from the processor 402 are communicated over a communication bus 404. The computer system 400 also includes a main memory 406, such as a Random Access Memory (RAM), where software may be executed during runtime, and a secondary memory 408. The secondary memory 408 includes, for example, a hard disk drive 410 and/or a removable storage drive 412, representing a floppy diskette drive, a magnetic tape drive, a compact disk drive, etc., or a nonvolatile memory where a copy of the software may be stored. Applications and some resources, such as files, may be stored in the secondary memory 408 and transferred to the main memory 406 during run time. Additionally, the application 102, the executables 104, and the polalaunchers 106, shown in FIG. 1, may be stored in the same manner. The secondary memory 408 may also include ROM (read only memory), EPROM (erasable, programmable ROM), EEPROM (electrically erasable, programmable ROM).

A user interfaces with the computer system 400 with one or more input devices 418, such as a keyboard, a mouse, a stylus, and the like. The display adaptor 422 interfaces with the communication bus 404 and the display 420 and receives display data from the processor 402 and converts the display data into display commands for the display 420. The user interacts with the application 102 through the use of the input devices 418 and display 420. A network interface 430 is provided for communicating with other nodes including the alert computer 116 via a network.

What has been described and illustrated herein are embodiments along with some of their variations. The terms, descriptions and figures used herein are set forth by way of illustration only and are not meant as limitations. Those skilled in the art will recognize that many variations are possible within the spirit and scope of the subject matter, which is intended to be defined by the following claims—and their equivalents—in which all terms are meant in their broadest reasonable sense unless otherwise indicated.

What is claimed is:

1. A method of launching an application in a computer system, the method comprising:
launching the application in a restricted user account;
intercepting at least one request for an operation on a file, the at least one request comes from launching the application;
determining whether the at least one file operation request is acceptable; and
responsive to the at least one file operation request determined to be acceptable, forwarding the file operation request for the operation on the file on behalf of the application launched in the restricted user account.

2. The method of claim 1, further comprising:
setting up the interception of the at least one file operation request in the application upon the launching of the application.

3. The method of claim 1, further comprising:
providing a user account with a first authority having access to a plurality of resources available in a computer system; and
providing the restricted user account with a second authority having access to a subset of the plurality of resources available in the computer system.

4. The method of claim 3, wherein forwarding the file operation request comprises:
forwarding the file operation request for the operation on the file with the first authority on behalf of the application launched in the restricted user account.

5. The method of claim 1, further comprising:
denying by default any and all file operation requests resulting from said launching the application prior to said determining whether the file operation request is acceptable.

6. The method of claim 1, further comprising:
denying by default any file operation request resulting from said launching the application based on predetermined file access types.

7. The method of claim 1, further comprising:
responsive to the at least one file operation request determined to be unacceptable,
diverting the file operation request to a target file separate from the file requested; and
performing the requested operation on the target file.

8. The method of claim 1, further comprising:
responsive to the at least one file operation request determined to be unacceptable, further determining whether the at least one file operation request is one of a creation of a new file, a reading of an existing file, and a writing to an existing file.

9. The method of claim 8, further comprising:
responsive to the at least one file operation request further determined to be one of a reading of an existing file and a writing to an existing file, providing an access denied error.

10. The method of claim 8, further comprising:
responsive to the at least one file operation request further determined to be a creation of a new file, diverting the file operation request to a target file separate from the file requested.

11. A method of providing confinement of access by an application to resources in a computer system, comprising:
providing a user with a user login account having a first predetermined authority to access the resources in the computer system;
providing the user with a restricted user account for the application based on the user login account, the restricted user account having a second predetermined authority with less access to the resources in the computer system than the first predetermined authority;
launching the application in the restricted user account;
intercepting at least one request for an operation on a file, the at least one request comes from launching the application;
determining whether the at least one file operation request is acceptable; and
responsive to the at least one file operation request determined to be unacceptable,
diverting the file operation request to a target file separate from the file requested; and
performing the requested operation on the target file.

12. The method of claim 11, further comprising:
responsive to the at least one file operation request determined to be acceptable,
forwarding with the first predetermined authority the file operation request for the operation on the file on behalf of the application launched in the restricted user account; and
providing direct interaction between the application and the requested file.

13. The method of claim 11, further comprising:
responsive to the at least one file operation request determined to be unacceptable, dynamically generating the target file prior to performing the requested operation on the target file.

14. The method of claim 11, further comprising:
deleting the target file upon completion of the file operation request by the launching application.

15. The method of claim 11, further comprising:
deleting the target file after one of a shutdown and a restart of the computer system.

16. The method of claim 11, wherein the second predetermined authority for the restricted user account is based on a requirement of the application to access the resources of the computer system.

17. The method of claim 11, further comprising:
responsive to the at least one file operation request determined to be unacceptable, providing an access-denied error.

18. The method of claim 11, further comprising:
responsive to the at least one file operation request determined to be unacceptable,
determining whether the at least one file operation request is a creation of a new file, and
diverting the file operation request to a target file separate from the file requested.

19. A computer readable medium on which is encoded program code for launching an application in a computer system, the program code comprising:
program code for launching the application in a restricted user account;
program code for intercepting at least one request for an operation on a file, the at least one request comes from launching the application;
program code for determining whether the at least one file operation request is acceptable; and
program code for forwarding the file operation request for the operation on the file on behalf of the application launched in the restricted user account in response to the at least one file operation request determined to be acceptable.

20. The computer readable medium of claim 19, further comprising:
program code for setting up the interception of the at least one file operation request in the application upon the launching of the application.
